(19) United States
(12) Patent Application Publication
(10) Pub. No.: US 2008/0267726 A1
(43) Pub. Date: Oct. 30, 2008

(54) Drill

(76) Inventor: Norihiro Masuda, Aichi (JP)

Correspondence Address: Muramatsu & Associates, 114 Pacifica, Suite 310, Irvine, CA, 92618, US

(21) Appl. No.: 11/988,576

(22) PCT Filed: Jul. 20, 2005
(86) PCT No.: PCT/JP2005/013319

§ 371 Date: Mar. 28, 2008

(51) Int. Cl. B23B 51/02

(52) U.S. Cl. 408/230

(57) ABSTRACT

A drill can achieve extended tool life while ensuring high machining efficiency. A flute length of the drill is set to be within a range of 6D or more and 10D or less relative to an outer diameter D of the cutting edge. At least the cutting edge has its surface coated with a hard compound and the film thickness dimension of the hard compound is set to 1.0 μm or less, and the number of cutting edges is set to two. As a result, chip dischargeability and rigidity of the drill can be synergistically improved. Therefore, the life of the drill can be synergistically improved.

### TECHNICAL FIELD

The present invention relates to drills, and more specifically to a drill that can achieve extended tool life while ensuring machining efficiency.

### BACKGROUND ART

Generally, wire-cut machining is a process in which electricity is passed through a wire mainly made of brass, and machining is performed by the electric discharge thus generated. To perform such machining, a starting hole through which the wire passes must be bored in a work material. With respect to a work material of high hardness, in particular, a starting hole is bored by electric discharge machining.

However, since the machining efficiency of electric discharge machining is extremely low, the overall machining efficiency of wire-cut machining decreases accordingly.

When drilling a hole in a material of high hardness with high accuracy to a tolerance of φ0.5 mm H7, according to the related art, pre-drilling is performed with a drill of φ0.4 mm, and then contouring is performed by wire cutting to ensure hole accuracy. However, this method requires extremely long machining time.

In view of this, Japanese Patent Application Laid-Open Publication NO. 2003-266223 discloses a technique related to a drill that can bore a starting hole even in a work material of high hardness. According to this technique, the axial length (flute length) of the chip discharge flutes is set within a range of 2D or more and 5D or less relative to the outer diameter D of the cutting edge, thereby making it possible to endure the rigidity of the drill.

As a result, the above-mentioned drill can bore a starting hole in a work material of high hardness without breaking, and provide improved machining efficiency in comparison to electric discharge machining, thereby making it possible to achieve a corresponding improvement in the overall machining efficiency of wire cutting.

Further, the process of finishing a hole with a tolerance of H7 by a combination of drilling and wire cutting can be replaced solely by the cutting process according to the present invention, thus allowing a reduction in machining time.

Patent Document 1: Japanese Patent Application Laid-Open Publication No. 2003-266223 (paragraph [0021], FIG. 2, etc.)

### DISCLOSURE OF THE INVENTION

### Problem to be Solved by the Invention

However, the above-described drill does not provide a sufficient measure for facilitating the discharge of chips. Consequently, breakage of the drill due to chip packing is caused, resulting in a decrease in tool life.

The present invention has been made with a view to solving the problems described above, and it is accordingly an object of the present invention to provide a drill that can achieve extended tool life while ensuring machining efficiency.

### Means for Solving the Problem

To achieve the object, the drill as defined in claim 1 includes:

a drill body that is rotated about a center axis; a flute portion formed in a spiral or substantially linear fashion in an outer peripheral surface portion from a tip of the drill body to a shank; a leading edge formed in a ridge portion between a wall surface facing a direction of rotation of the flute portion and the outer peripheral surface portion; and a cutting edge formed at the tip of the drill body.

A flute length of the flute portion which is a dimension along the center axis of the drill body is set to be within a range of 6D or more and 10D or less relative to an outer diameter D of the cutting edge.

At least the cutting edge has its surface coated with a hard compound the and a film thickness dimension of the hard compound is set to 1.0 μm or less and the cutting edge includes two edges.

According to the drill as defined in claim 2, in the drill as defined in claim 1, the outer diameter D of the cutting edge is set to 1.0 mm or less.

According to the drill as defined in claim 3, in the drill as defined in claim 1 or 2, a thickness dimension of a web thickness formed by a flute bottom of the flute portion is set to be within a range of 0.35D or more and 0.55D or less relative to the outer diameter D of the cutting edge.

According to the drill as defined in claim 4, in the drill as defined in any one of claims 1 to 3, the hard compound is adhered onto the cutting edge by a sputtering method after performing surface roughening means for impinging positive ions on a surface of the cutting edge through application of a negative bias voltage to the cutting edge, and the surface roughening means applies the bias voltage periodically at a frequency that is set within a range of 0 kHz or more and 350 kHz or less.

According to the drill as defined in claim 5, in the drill as defined in claim 4, the surface roughening means applies the bias voltage periodically at a frequency that is set within a range of 150 kHz or more and 350 kHz or less, and a non-application time of a negative voltage at every one cycle is set to be within a range of 50 nsec or more and 2000 nsec or less.

### EFFECT OF THE INVENTION

According to the drill as defined in claim 1, the flute length of the flute portion corresponding to a dimension along the center axis of the drill body is set to be within the range of 6D or more and 10D or less relative to the outer diameter D of the cutting edge. In this regard, if the flute length is smaller than 6D, chip dischargeability decreases, causing drill breakage due to chip packing. On the other hand, if the flute length is larger than 10D, the rigidity of the drill decreases, causing drill breakage. For these reasons, by setting the flute length to be within the range of 6D or more and 10D or less, there is an effect in that chip dischargeability and the rigidity of the drill are ensured to prevent drill breakage, thereby making it possible to extend the life of the drill.

Since at least the surface of the cutting edge is coated with a hard compound, there is an effect in that wear resistance of the cutting edge can be ensured to achieve extended life of the drill.

Further, the film thickness dimension of the hard compound is set to 1.0 μm or less. In this regard, if the film thickness dimension of the hard compound is larger than 1.0 μm, the cutting edge becomes rounded, resulting in a decrease in sharpness. As a result, the chip breaking performance deteriorates, causing drill breakage due to chip packing. In contrast, if the film thickness dimension of the hard compound is set to 1.0 μm or less as described above, there is an effect in that a decrease in sharpness is suppressed to prevent drill breakage, thereby making it possible to extend the life of the drill.

Further, since the cutting edge is made up of two edges, as compared with the case where the cutting edge is made up of three edges, it is possible to ensure edge thickness, which is a dimension of thickness from the leading edge to the heel as seen in the direction of the center axis. Therefore, there is an effect in that the rigidity of the drill is ensured to prevent drill breakage, thereby making it possible to extend the life of the drill.

Further, by setting the flute length, the film thickness dimension of the hard compound, and the number of cutting edges to be within the above-mentioned ranges and using them in combination, chip dischargeability and rigidity of the drill can be synergistically improved. As a result, there is an effect in that the life of the drill can be synergistically improved.

According to the drill as defined in claim 2, in addition to the effect provided by the drill as defined in claim 1, the drill is formed by a so-called small-diameter drill with the outer diameter D of its cutting edge set to 1.0 mm or less. Therefore, by preventing drill breakage, it is possible to machine a large number of small-diameter holes.

That is, by setting the flute length to be within the range of 6D or more and 10D or less relative to the outer diameter D of the cutting edge as described above, it is possible to ensure chip dischargeability and rigidity of the drill. As a result, there is an effect in that the life of a small-diameter drill, for which it is difficult to ensure rigidity as a whole, can be extended.

Further, as described above, the film thickness dimension of the hard compound is set to 1.0 mm or less. In this regard, in the case of a small-diameter drill, the film thickness dimension of the hard compound becomes large relative to the cutting edge, which significantly affects sharpness. As a result, if the film thickness dimension of the hard compound is larger than 1.0 mm, the cutting edge becomes rounded, resulting in a decrease in sharpness. In this regard, by setting the film thickness dimension of the hard compound to 1.0 mm or less, there is an effect in that drill breakage can be effectively prevented.

Further, as described above, the number of cutting edges is set to two, so the rigidity of the drill as a whole can be ensured. As a result, there is an effect in that the life of a small-diameter drill, for which it is difficult to ensure rigidity as a whole, can be extended.

From these reasons, by setting the film thickness dimension of the hard compound, and the number of cutting edges to be within the above-mentioned ranges and using them in combination, it is possible to extend drill life more effectively, particularly with respect to a small-diameter drill with the outer diameter D of its cutting edge set to 1.0 mm or less.

According to the drill as defined in claim 3, in addition to the effect provided by the drill as defined in claim 1 or 2, the thickness dimension of the web thickness formed by the flute bottom of the flute portion is set to be within the range of 0.35D or more and 0.55D or less relative to the outer diameter D of the cutting edge. In this regard, if the thickness dimension of the web thickness is smaller than 0.35D, the rigidity of the drill decreases, making the taper of the drill to breakage.

On the other hand, if the thickness dimension of the web thickness is larger than 0.55D, the flute portion becomes shallow, resulting in a decrease in chip dischargeability. As a result, chip welding is induced, causing drill breakage. For these reasons, by setting the thickness dimension of the web thickness to be within the range of 0.35D or more and 0.55D or less, there is an effect in that the rigidity of the drill and chip dischargeability can be ensured and, as a result, the life of the drill can be extended.

According to the drill as defined in claim 4, in addition to the effect provided by the drill as defined in any one of claims 1 to 3, the hard compound is adhered onto the cutting edge by a sputtering method after performing surface roughening treatment by impinging positive ions on the surface of the cutting edge through periodic application of a negative bias voltage to the cutting edge at a frequency that is set within a range of 0 kHz or more and 350 kHz or less. Since the bias voltage is changed periodically when performing the surface roughening treatment in this way, there is an effect in that the adhesion strength of the hard compound to the cutting edge is improved, thereby making it possible to attain good adhesion strength with a critical load of 80 N or more in scratch test, for example.

Further, since the hard compound is adhered to the cutting edge by a sputtering method, for example, the average diameter of fine particles called macroparticles that are present on the surface of the hard compound can be made 10 μm or less, and also the ratio of the area occupied by the macroparticles can be made 10% or less. As a result, there is an effect in that a relatively smooth coating surface can be obtained without performing machining such as polishing.

According to the drill as defined in claim 5, in addition to the effect provided by the drill as defined in claim 4, in the surface roughening treatment, the bias voltage is applied periodically at a frequency that is set within a range of 150 kHz or more and 350 kHz or less, and the non-application time of a negative voltage at every one cycle is set to be within a range of 50 nsec or more and 2000 nsec or less. Accordingly, there is an effect in that the adhesion strength of the hard compound to the cutting edge can be significantly improved.

### BRIEF DESCRIPTION OF THE DRAWINGS

FIG. 1 is a front view of a drill according to an embodiment of the present invention.

FIG. 2 is a view of the tip face of the drill.

FIG. 3 is a diagram showing an etching step of roughening the surface of a drill, of which (a) is a schematic diagram of a sputtering device in the etching step, and (b) is a state diagram showing the time variation of a bias voltage.

FIG. 4 is a schematic diagram of a sputtering device in a sputtering step.

FIG. 5 is a diagram showing enlarged photographs of a drill, of which (a) is a view showing enlarged photographs of a drill according to this embodiment, and (b) is a view showing enlarged photographs of a drill according to the related art.

FIG. 6 is a diagram showing the results of a first endurance test.

FIG. 7 is a diagram showing the results of endurance tests, of which (a) is a diagram showing the results of a second endurance test, and (b) is a diagram showing the results of a third endurance test.

FIG. 8 is a diagram showing the results of efficiency tests, of which (a) is a diagram showing the results of a fourth efficiency test, (b) is a diagram showing the results of a fifth efficiency test, (c) is a view showing a photograph of the cross-section of a machined hole machined by using the drill according to the present invention, and (d) is a view showing a photograph of the cross-section of a machined hole machined by electric discharge machining.

### DESCRIPTION OF REFERENCE NUMERALS AND SYMBOLS

1 Drill

2 Shank

3 Drill body

4 Flute portion

5 Cutting edge

6 Leading edge

1 Flute length

D Outer diameter of cutting edge

O Center axis

W Thickness dimension of web thickness

### BEST MODE FOR CARRYING OUT THE INVENTION

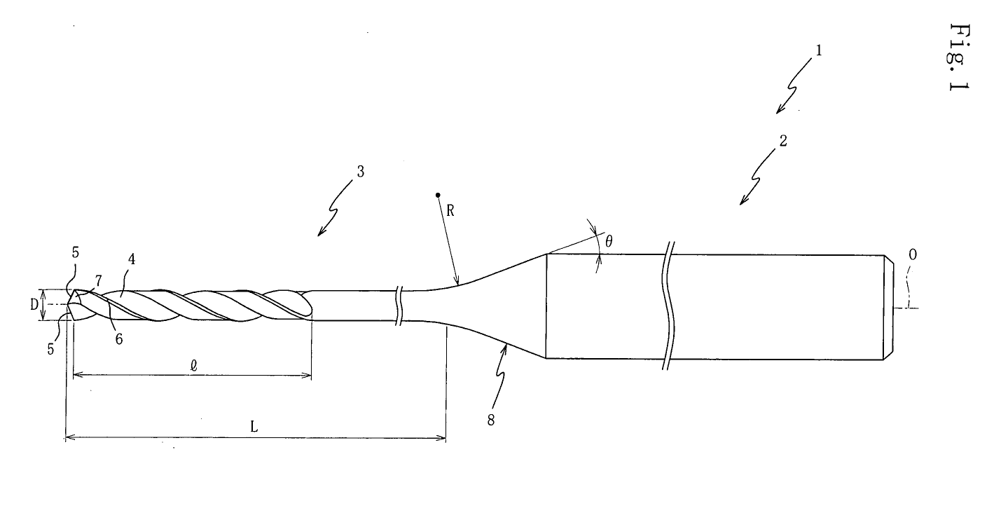

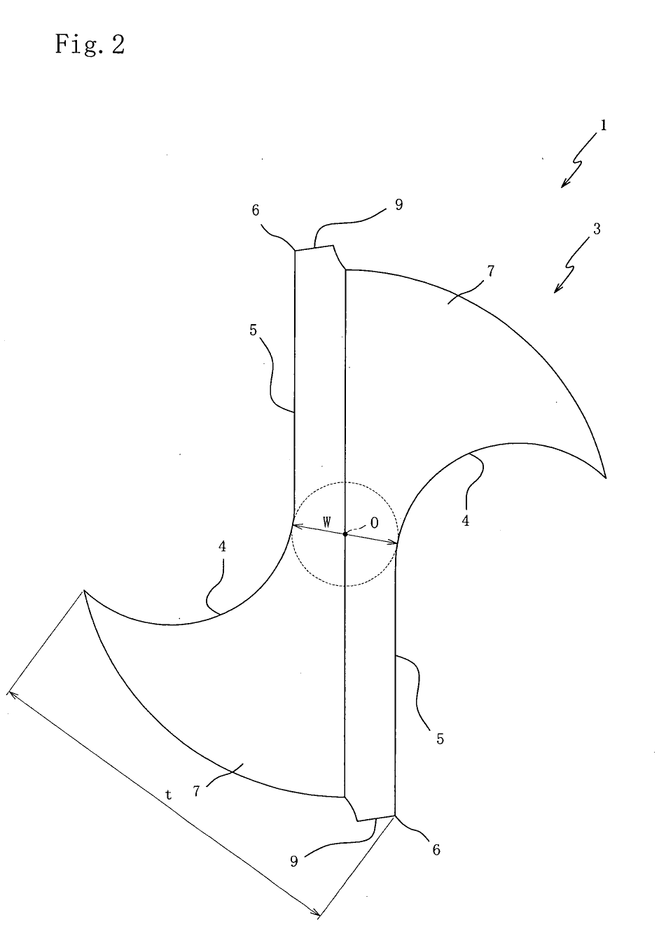

Hereinbelow, preferred embodiments of the present invention will be described with reference to the attached drawings. FIG. 1 is a front view of a drill 1 according to an embodiment of the present invention. It should be noted that illustration of the axial lengths of a shank 2 and a drill body 3 is omitted in FIG. 1.

The drill 1 is a cutting tool of a small diameter for boring a starting hole through which a wire passes when performing mainly wire-cut machining, by means of torque transmitted from machining equipment (drill press or the like). As shown in FIG. 1, the drill 1 mainly includes the shank 2 held by the above-mentioned machining equipment, and the drill body 3 that performs cutting of a work material.

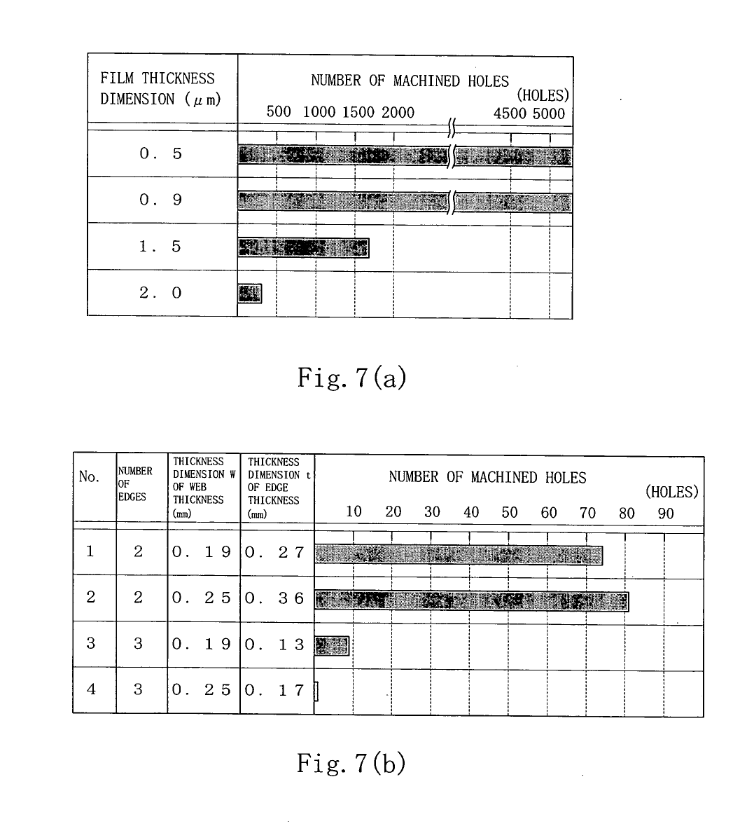

It should be noted that the surface of the drill 1 is coated with TiAlN that is a hard compound by a sputtering method described later, and the film thickness dimension of TiAlN is set to be 1.0 μm or less. Detailed description will be given in this regard later (see FIG. 7(a)).

The drill 1 according to this embodiment is made of a cemented carbide obtained by adding cobalt as a binder to fine powder of tungsten carbide with an average grain size of 1.0 μm or less, and pressure-sintering the resultant powder, thus ensuring the hardness of the drill 1. However, this should not be construed restrictively. The drill 1 may be made of a hard tool material such as cermet or CBN (Cubic Boron Nitride) sintered body, or a steel material such as powder high speed steel (sintered high speed steel), high speed tool steel, or alloy tool steel.

The shank 2 is the portion held by the machining equipment. In this embodiment, the outer diameter dimension of the shank 2 is set to be larger than the outer diameter D of a cutting edge 5, and the shank 2 is formed so as to extend straight substantially in parallel to the center axis O.

The drill body 3 mainly includes a flute portion 4 formed in a spiral fashion in the outer peripheral surface portion thereof, the cutting edge 5 formed at the tip of the drill body 3, and a leading edge 6 formed in the ridge portion between the wall surface facing toward the direction of rotation of the flute portion 4 and the outer peripheral portion, and a relief surface 7 connected to the rear in the rotational direction of the cutting edge 5. The drill body 3 is formed integrally with the shank 2 via a joint portion 8.

The flute portion 4 corresponds to flutes recessed into the outer peripheral surface portion of the drill body 3 in order to discharge chips, with the leading edge 6 arranged in the ridge portion between the wall surface facing toward the direction of rotation and the outer peripheral surface portion.

While the flute portion 4 according to this embodiment is formed in a spiral fashion from the distal end side (left side in FIG. 1) toward the shank 2, this should not be construed restrictively. The flute portion 4 may be formed linearly so as to be substantially parallel to the center axis O.

It is desirable that the helix angle, which is an angle formed between the leading edge 6 and a straight line parallel to the center axis O, be set to be within the range of 15 degrees or more and 35 degrees or less. This makes it possible to ensure the rigidity of the drill body 3 and chip dischargeability.

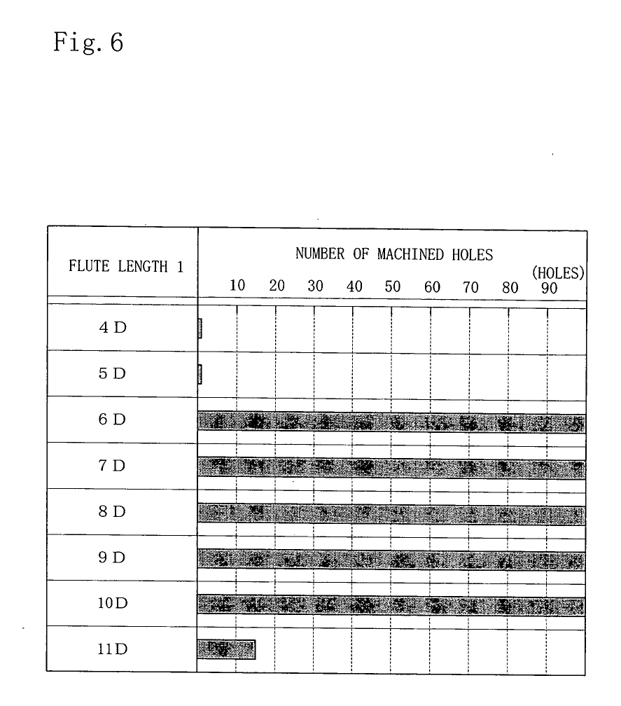

It is desirable that the flute length 1 as a dimension along the center axis O of the flute portion 4 be set within the range of 6D or more and 10D or less relative to the outer diameter D of the cutting edge 5. Detailed description will be given in this regard later (see FIG. 6).

The cutting edge 5 is used for drilling a hole in a work material by means of torque from machining equipment, and arranged at the tip of the drill body 3.

While the point angle of the cutting edge 5 is set to 120 degrees in this embodiment, this should not be construed restrictively. The point angle may be set to be within the range of 110 degrees or more and 140 degrees or less. This makes it possible to ensure the strength and biting of the cutting edge 5, thereby ensuring hole accuracy and extending the life of the drill 1.

The relief surface 7 is a surface that is relieved to reduce friction at the time of cutting, and is connected to the rear in the rotational direction of the cutting edge 5.

The joint portion 8 is a portion connecting between the drill body 3 and the shank 2, and is tapered so as to curve and increase in diameter from the drill body 3 toward the shake 2. It should be noted that the taper angle θ of the joint portion 8 according to this embodiment is set to 20 degrees, and the arc radius R thereof is set to 10. Accordingly, in the drill 1 according to this embodiment whose drill body 3 has a large axial dimension L (dimension in the left-right direction in FIG. 1), in particular, it is possible to effectively mitigate stress concentration at the time of machining to prevent breakage of the drill 1.

Next, the tip of the drill body 3 will be described with reference to FIG. 2. FIG. 2 is a view of the tip face of the drill 1.

A margin 9 is for polishing the inner wall surface of a machined hole, and connected to the rear in the rotational direction of the cutting edge 5 (clockwise in FIG. 2). While one margin 9 is provided in this embodiment, this should not be construed restrictively. A second margin may be arranged in the rear in the rotational direction of the margin 9.

It is desirable that the thickness dimension W of the web thickness formed by the flute bottom of the flute portion 4 be set to be within the range of 0.35D or more and 0.55D or less relative to the outer diameter D of the cutting edge 5. In this regard, if the thickness dimension W of web thickness is smaller than 0.35D, the rigidity of the drill 1 decreases, making the drill 1 prone to breakage.

On the other hand, if the thickness dimension W of web thickness is larger than 0.55D, the flute portion 4 becomes shallow, leading to a decrease in chip dischargeability. As a result, welding of chips is induced, causing breakage of the drill 1. For these reasons, by setting the thickness dimension W of web thickness to be within the range of 0.35D or more and 0.55D or less, the rigidity of the drill 1 and chip dischargeability can be ensured. As a result, it is possible to extend the life of the drill 1.

It should be noted that the thickness dimension W of web thickness is changed to a variety of values according to the hardness of a work material. For example, when machining a hard material with a hardness exceeding 50 HRC, it is desirable to set the thickness dimension W of web thickness to be within the range of 0.45D or more and 0.55D or less in order to ensure the rigidity of the drill 1. On the other hand, when machining a soft material with a hardness of 40 HRC, it is desirable to set the thickness dimension W of web thickness to be within the range of 0.35D or more and 0.45D or less in order to ensure chip dischargeability.

In the drill 1 according to this embodiment, the number of the cutting edges 5 is set to two, thus securing the thickness dimension t of the edge thickness from the leading edge 6 to the heel. Detailed description will be given in this regard later (see FIG. 7(b)).

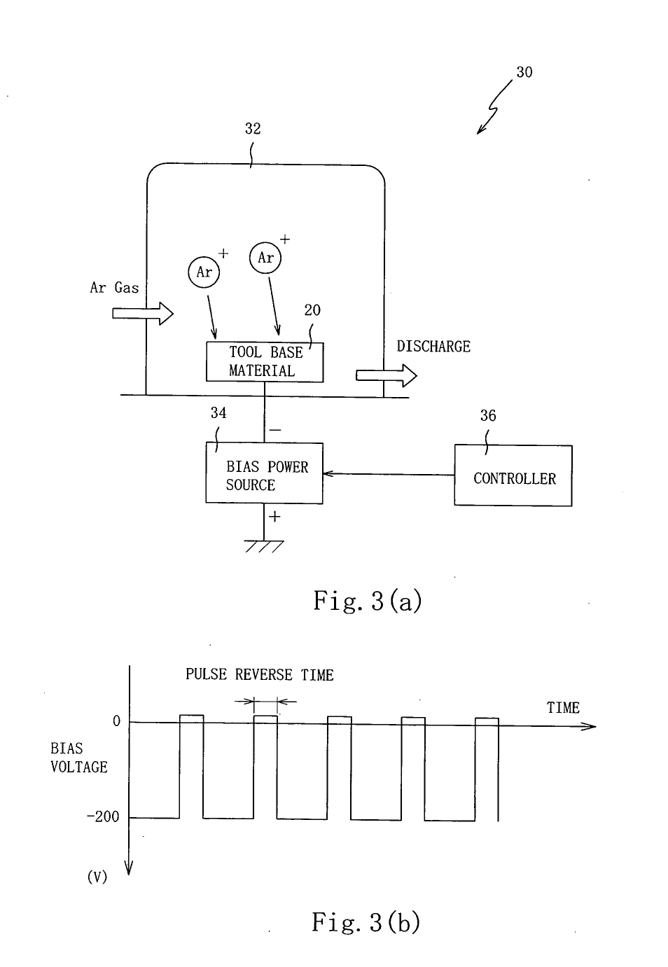

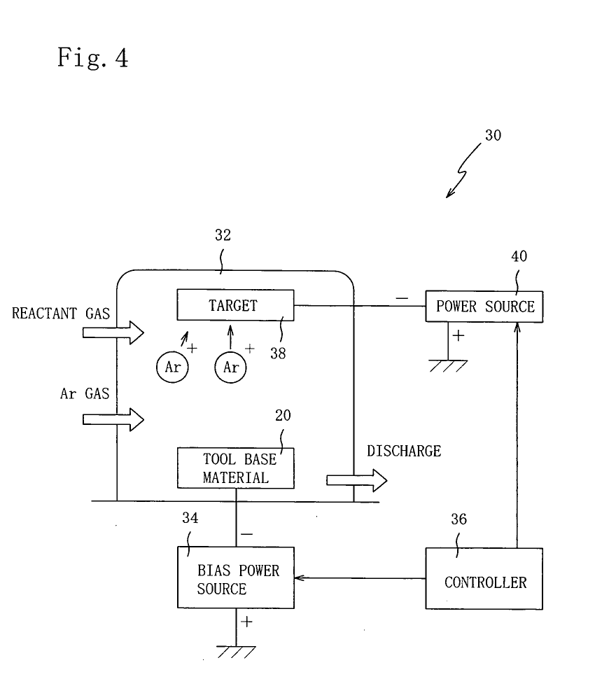

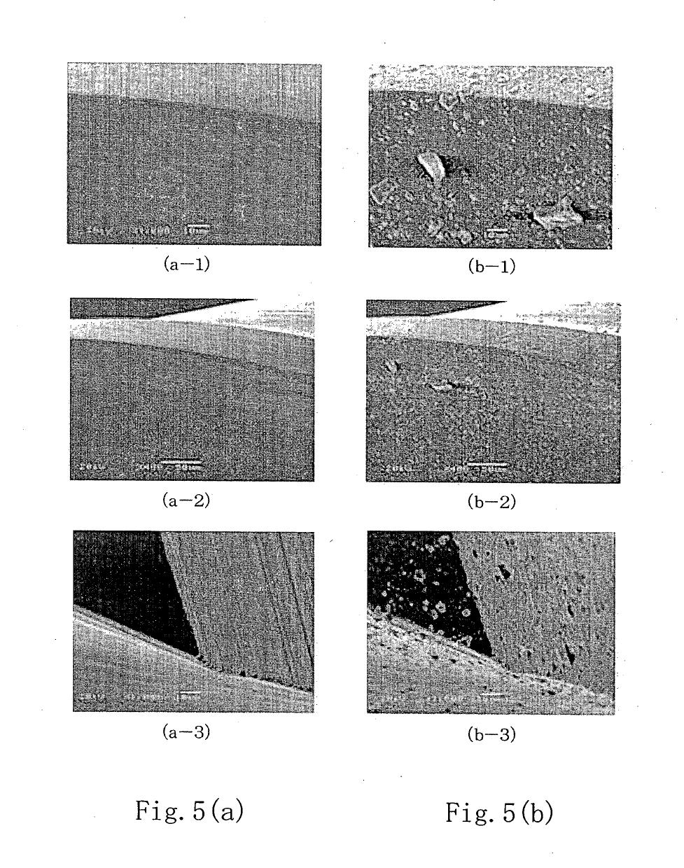

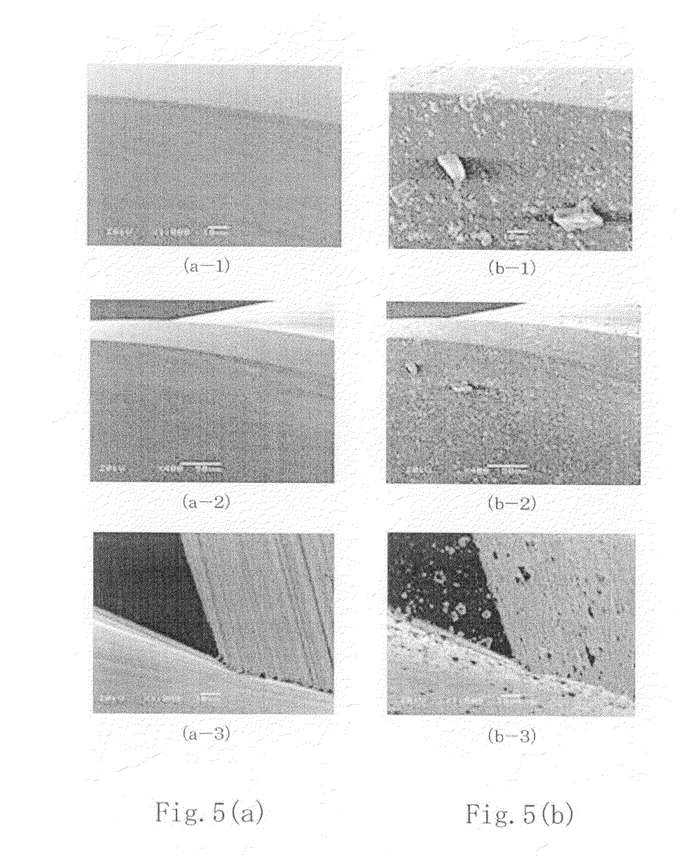

Next, a method of coating a hard compound will be described with reference to FIGS. 3 to 5. FIG. 3 is a diagram showing an etching step for roughening the surface of the drill 1. FIG. 3(a) is a schematic diagram of a sputtering device 30 in the etching step, and FIG. 3(b) is a state diagram showing the time variation of a bias voltage. FIG. 4 is a schematic diagram of the sputtering device 30 in a sputtering step. FIG. 5 is a view showing enlarged photographs of the drill 1. FIG. 5(a) is a view showing enlarged photographs of the drill 1 according to this embodiment, and FIG. 5(b) is a view showing enlarged photographs of a drill according to the related art.

In the etching step, as shown in FIG. 3(a), a negative bias voltage is applied to a tool base material 20 arranged within a chamber 32 from a bias power source 34, thereby impinging positive argon ions Ar⁺ on the tool base material 20 for surface roughening.

At this time, in this embodiment, the bias voltage is changed periodically by a controller 36 as shown in FIG. 3(b). Specifically, a negative bias voltage of −200 V is applied in a pulse mode at a frequency of 250 kHz. A reverse voltage on the positive side (for example, about +20 V) is applied during the application time of a negative voltage at every one cycle, and pulse reverse time as a non-application time of that negative voltage (application time of a reverse voltage) is approximately 5000 nsec, which is about one eighth of one period (4000 nsec). It should be noted that the surface roughening step as defined in claim 4 means an etching step.

In the sputtering step, as shown in FIG. 4, a constant negative bias voltage (for example, about −50 V to −60 V) is applied from a power source 40 to a target 38 such as TiAl or Ti constituting a hard compound, and also a constant negative bias voltage (for example, about −100 V) is applied to the tool base material 20 from the bias power source 34, thereby impinging argon ions Ar⁺ on the target 38 to strike out constituent substances such as TiAl or Ti. In addition to argon gas, reactant gas such as nitrogen gas or hydrocarbon gas (CH₄, C₂H₂) is introduced into the chamber 32 at a predetermined flow rate, and its nitrogen atoms N or carbon atoms C become TiAlN, TiCN, TiN, or the like struck out from the target 38 and are adhered onto the surface of the tool base material 20 as a hard coating. It should be noted that a positive voltage may be applied to the tool base material 20.

As shown in FIG. 5, (a) ((a-1), (a-2), and (a-3)) represents a case in which TiAlN is coated onto a drill made of cemented carbide by the same coating method (etching and sputtering at −200 V, 250 kHz, pulse reverse time=500 nsec) as that of the embodiment mentioned above, and(b)((b-1), (b-2), and (b-3)) represents a case in which TiAlN is coated onto a drill of the same configuration by an arc ion plating method. It should be noted that (a-1) and (b-1), (a-2) and (b-2), and (a-3) and (b-3) are photographs of the same section of the cutting edge magnified by 1000 times with a scanning electron microscope.

As is apparent from the respective photographs of FIG. 5, as compared with the drill of the related art according to the arc ion plating method (see FIG. 5(b)), the drill 1 according to the present invention (see FIG. 5 (a)) provides an extremely smooth coating surface with few fine particles called macroparticles on the surface. In the area measured in these photographs, the maximum diameter of macroparticles in the drill of the related art was about 18 μm and the area occupied by the macroparticles was 20%, whereas the maximum diameter of macroparticles in the drill 1 according to the present invention was about 6 μm and the area occupied by the macroparticles was 6%.

From the above, according to the drill 1 of this embodiment, since a hard compound is adhered by a sputtering method, the maximum diameter of macroparticles that are present on the surface of the hard compound is 10 μm or less, and the ratio of the area occupied by the macroparticles is 10% or less, thus providing a smooth coating surface. This allows an improvement in terms of the machined surface roughness of the work material being cut with the above-mentioned drill 1, and eliminates the necessity of polishing or the like for removing protrusions on the coating surface due to macroparticles.

As a pretreatment for the adhesion of a hard compound by a sputtering method, at the time of performing etching (surface roughening treatment) by application of a bias voltage of −200 V to the tool base material 20, the bias voltage is applied periodically at a frequency of 250 kHz, and the non-application time (pulse reverse time) of the negative voltage at every one cycle is set to about 5000 nsec, thereby achieving enhanced adhesion strength of the hard compound to the tool base material 20. For example, good adhesion strength with a critical load of 100 N or more in scratch test is attained, and falling of the hard compound due to peeling or the like is suppressed, thus achieving satisfactory durability for practical use as a cutting tool.

While the bias voltage is adapted to change in a pulse-like, that is, a rectangular shape in this embodiment, this should not be construed restrictively. For example, the bias voltage may be adapted to change in another shape, such as a continuously changing waveform.

While the non-application time of a negative voltage at every one cycle is set to be within the range of 50 to 2000 nsec, this may be set to ½ or less with reference to one cycle, or to be within the range of 1/100 to ½ or 1/50 to ½ of one cycle, for example.

Next, referring to FIGS. 6 to 9, description will be made of the results of 6 kinds of cutting test (hereinbelow, respectively referred to as “first endurance test” to “third endurance test”, and “fourth efficiency test” to “sixth efficiency test”) conducted using the drill 1 configured as described above. In the following description, the same symbols as those used for the drill 1 described above are used (for example, “D” for indicating the outer diameter of the cutting edge 5).

FIG. 6 is a diagram showing the results of a first endurance test. The first endurance test is a test conducted to examine how the flute length 1 affects the durability of the drill 1. Referring to FIG. 6, the test is conducted by varying the value of the flute length 1 within a fixed range while keeping other cutting conditions constant.

In this test, at a predetermined cutting speed V and feed rate f, drilling to a hole depth of 5 mm is carried out by STEP machining, and the number of holes thus drilled are calculated for a comparison of the durability of the drill 1.

STEP machining is a process in which the depth of a machined hole is increased stepwise as the drill 1 is fed into and out of a hole to be machined while discharging chips in the flute portion 4 upon exiting the machined hole. That is, until the flute portion 4 becomes completely buried in the machined hole, machining is performed without stopping as chips are discharged through the flute portion 4. After the flute portion 4 becomes completely buried in the machined hole, chips are discharged by pulling out the drill 1 from the machined hole. Then, the drill 1 is advanced into the machined hole, and cutting of the machined hole is performed on the basis of a preset STEP amount. The drill 1 is then pulled out from the machined hole again to discharge chips. The above operations are repeated until a target machined hole depth is reached.

The detailed specifications of the first endurance-test are as follows: Work Material: SKD11(60HRC), Machining Depth: 5 mm, Outer Diameter D of Cutting Edge: 0.5 mm, Axial Dimension L of Drill Body: 14 D, Cutting Speed V: 31.5 m/min, Feed Rate f: 0.02 mm/rev, and STEP amount: 0.05 mm.

As shown in FIG. 6, in a case where the drill 1 with the flute length 1 set to 4D and 5D was used, the drill 1 broke after drilling 1 hole, making subsequent drilling difficult.

Next, in a case where the drill 1 with the flute length 1 set within the range of 6D to 10D was used, the drill 1 did not break even after drilling 100 holes, and it was possible to continue drilling thereafter.

Next, in a case where the drill 1 with the flute length 1 set to 11D was used, the drill 1 broke after drilling 15 holes, making subsequent drilling difficult.

From the above results, it is presumed that if the flute length 1 is 6D or less, chip dischargeability cannot be ensured, causing breakage of the drill 1 due to chip packing. On the other hand, if the flute length 1 is larger than 10D, the rigidity of the drill 1 decreases, causing breakage of the drill 1.

Accordingly, it can be said that if the flute length 1 is set within the range of 6D or more and 10D or less, it is possible to ensure chip dischargeability and rigidity of the drill 1, thereby preventing breakage of the drill 1 to achieve extended life of the drill 1.

Next, FIG. 7 is a diagram showing the results of endurance tests. FIG. 7(a) is a diagram showing the results of a second endurance test, and FIG. 7(b) is a diagram showing the results of a third endurance test.

First, a second endurance test will be described with reference to FIG. 7(a). The second endurance test is a test conducted to examine how the film thickness dimension of a hard compound affects the durability of the drill 1. Referring to FIG. 7(a), the test is conducted by varying the value of the film thickness dimension of a hard compound within a fixed value while keeping other cutting conditions constant.

In this test, at a predetermined cutting speed V and feed rate f, drilling to a hole depth of 15 mm is carried out by STEP machining, and the number of holes thus drilled are calculated for a comparison of the durability of the drill 1.

The detailed specifications of the second endurance test are as follows: WorkMaterial:SUS420, Machining Depth: 15 mm, Outer Diameter D of Cutting Edge: 0.5 mm, Axial Dimension L of Drill Body: 30 D, Cutting Speed V: 25 m/min, Feed Rate f: 0.01 mm/rev, and STEP amount: 0.1 mm.

As shown in FIG. 7(a), in a case where the drill 1 with the film thickness dimension set to 0.5 μm and 0.9 μm was used, the drill 1 did not break even after drilling 5000 holes, and it was possible to continue drilling thereafter.

Next, in a case where the drill 1 with the film thickness dimension set to 1.5 μm was used, the drill 1 broke after drilling 1690 holes, making subsequent drilling difficult.

Next, in a case where the drill 1 with the film thickness dimension set to 2.0 μm was used, the drill 1 broke after drilling 283 holes, making subsequent drilling difficult.

From the above results, it is presumed that if the film thickness is more than 1.0 μm, the cutting edge 5 becomes rounded, resulting in a decrease in sharpness. In particular, since the drill 1 according to the present invention is formed by a small-diameter drill whose outer diameter D is set to 0.5 mm, the film thickness dimension becomes large relative to the cutting edge 5, which significantly affects sharpness. It is presumed that the chip breaking performance significantly deteriorates as a result, causing breakage of the drill 1 due to chip packing.

Accordingly, it can be said that if the film thickness dimension of a hard compound is set to 1.0 μm or less, it is possible to suppress a decrease in chip breaking performance due to a decrease in sharpness, thereby preventing breakage of the drill 1 due to chip packing and effectively extending the life of the drill 1.

While in this embodiment TiAlN is used as the hard compound, this should not be construed restrictively. A hard compound such as TiN, TiC, or TiCn may be used as well. Further, although the entire surface of the drill 1 is coated with the hard compound, this should not be construed restrictively. It suffices that at least the surface of the cutting edge 5 is coated with the hard compound.

Next, a third endurance test will be described with reference to FIG. 7(b). The third endurance test is a test conducted to examine how the number of the cutting edges 5 affects the durability of the drill 1. Referring to FIG. 7(b), the test is conducted by varying the number, thickness dimension W of web thickness, and thickness dimension t of edge thickness of the cutting edges 5 within a fixed range while keeping other cutting conditions constant.

In this test, at a predetermined cutting speed V and feed rate f, drilling to a hole depth of 15 mm is carried out by STEP machining, and the number of holes thus drilled are calculated for a comparison of the durability of the drill 1.

The detailed specifications of the third endurance test are the same as the detailed specifications of the second endurance test described above, except for that the work material is SKD11 and the cutting speed V is fixed at 30 m/min.

As shown in column No. 1, in a case where the number of the cutting edges 5 is set to 2, the thickness dimension W of web thickness is set to 0.19 mm, and the thickness dimension t of edge thickness is set to 0.27 mm, the drill 1 was able to drill 74 holes before breaking. The presumed reason for this is that by setting the number of the cutting edges 5 to two, it was possible to ensure the thickness dimension t of edge thickness, that is, the rigidity of the drill 1 to thereby extend the life of the drill 1.

Next, as shown in column No. 2, in a case where the number of the cutting edges 5 is set to two, the thickness dimension W of web thickness is set to 0.25 mm, and the thickness dimension t of edge thickness is set to 0.36 mm, the drill 1 was able to drill 81 holes before breaking. The presumed reason for this is that as in the case of the drill 1 of No. 1, it was possible to ensure the rigidity of the drill 1 to thereby extend the life of the drill 1.

It is also presumed that since the thickness dimension W of web thickness and thickness dimension t of edge thickness of the drill 1 of No. 2 are larger than those of the drill 1 of No. 1, it was possible to further ensure the rigidity of the drill 1 to thereby extend the life of the drill 1.

Next, as shown in column No. 3, in a case where the number of the cutting edges 5 is set to three, the thickness dimension W of web thickness is set to 0.19 mm, and the thickness dimension t of edge thickness is set to 0.13 mm, the drill 1 broke after drilling 9 holes, making subsequent drilling difficult. The presumed reason for this is that by setting the number of the cutting edges 5 to three, the thickness dimension t of edge thickness, that is, the rigidity of the drill 1 could not be ensured, and the drill 1 thus broke.

Next, as shown in column No. 4, in a case where the number of the cutting edges 5 is set to three, the thickness dimension W of web thickness is set to 0.25 mm, and the thickness dimension t of edge thickness is set to 0.17 mm, the drill 1 broke after drilling 1 hole, making subsequent drilling difficult. The presumed reason for this is that as in the case of the drill 1 of No. 3, the rigidity of the drill 1 could not be ensured, and the drill 1 thus broke.

It should be noted that the life of the drill 1 of No. 4 is short even through its thickness dimension W of web thickness and thickness dimension t of edge thickness are large as compared with the drill 1 of No. 3. This is presumably due to an experimental error.

From the above results, by setting the number of the cutting edges 5 to two, it is possible to ensure the thickness dimension t of the cutting edge 5, that is, the rigidity of the drill 1 to thereby extend the life of the drill 1. In particular, in a case where the drill 1 is formed by a small-diameter drill whose outer diameter D is set to 0.5 mm as in this embodiment, it is difficult to ensure the rigidity of the drill 1. Accordingly, setting the number of the cutting edges 5 to two proves effective in extending the life of the drill 1.

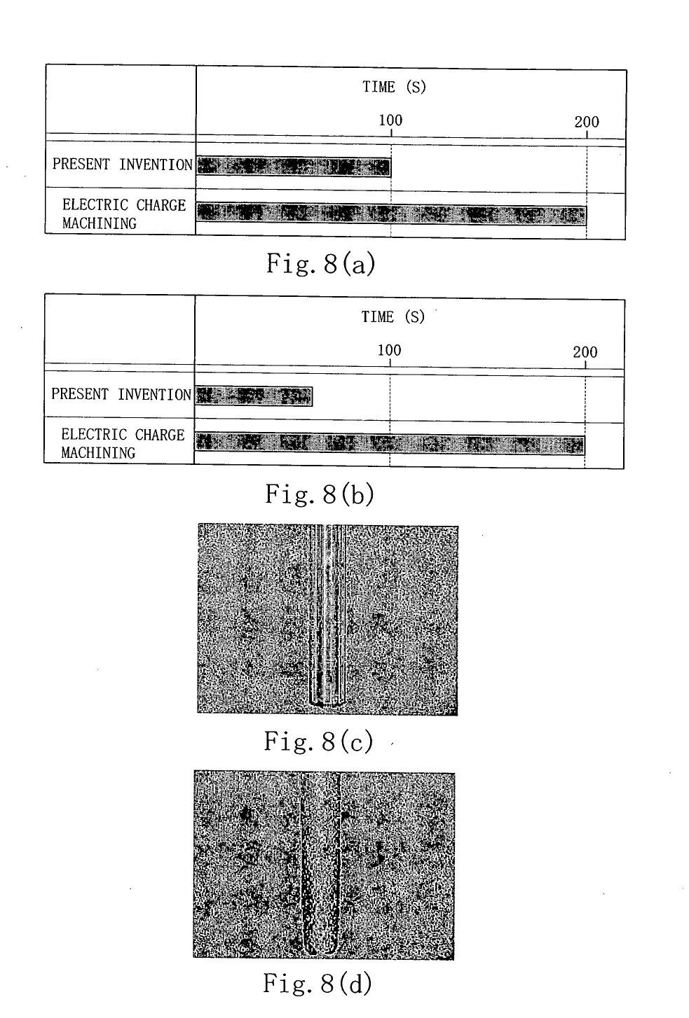

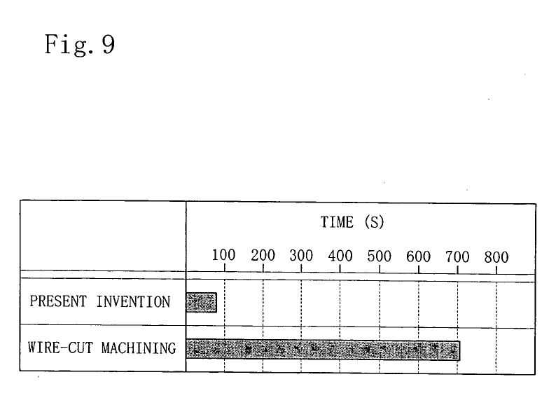

Next, FIG. 8 is a diagram showing the results of efficiency tests. FIG. 8(a) is a diagram showing the results of a fourth efficiency test, FIG. 8(b) is a diagram showing the results of a fifth efficiency test, FIG. 8(c) is a view showing a photograph of the cross-section of a machined hole machined using the drill 1 according to the present invention, and FIG. 8(d) is a photograph of the cross-section of a machined hole machined by electric discharge machining.

First, the fourth and fifth efficient tests will be described with reference to FIGS. 8(a) and 8(b). The fourth and fifth efficient tests are tests conducted to examine the cutting efficiency of the drill 1 according to the present invention. In these tests, at a predetermined cutting speed V and feed rate f, machining of a starting hole to a machining depth of 15 mm is carried out by STEP machining, and the time required for machining the starting hole is calculated for a comparison in efficiency between machining using the drill 1 according to the present invention and electric discharge machining.

The detailed specifications of the fourth efficiency test are as follows: Work Material: SKD11 (raw material), Machining Depth: 15 mm, Cutting Fluid: water-miscible cutting fluid, Outer Diameter D of Cutting Edge: 0.5 mm, Axial Dimension L of Drill body: 30 D, Cutting Speed V: 31.4 m/min, Feed Rate f: 0.01 mm/rev, and STEP amount: 0.1 mm.

The detailed specifications of the fifth efficiency test are the same as the detailed specifications of the fourth efficiency test described above, except for that the work material is HPM31, and the feed rate f and the STEP amount are fixed at 0.015 mm/rev and 0.15 mm, respectively.

As shown in FIG. 8(a), the time required for machining was 100 s (seconds) in a case where the drill 1 according to the present invention was used, whereas the time required for machining was 200 s in the case of electric discharge machining.

Further, as shown in FIG. 8(b), the time required for machining was 60 s (seconds) in a case where the drill 1 according to the present invention was used, whereas the time required for machining was 200 s in the case of electric discharge machining.

From the above results, in the case of using the drill 1 according to the present invention, cutting efficiency can be enhanced by more than twice in comparison to the case of electric discharge machining. That is, an improvement can be achieved in terms of the cutting efficiency for a starting hole to thereby achieve a corresponding improvement in the efficiency of wire-cut machining.

It should be noted that as shown in FIGS. 8(c) and 8(d), the cross-section of the machined hole machined using the drill 1 according to the present invention is very smooth as compared with the cross-section of the machined hole machined by electric discharge machining. Further, the value of the surface roughness Ry (maximum height; see Japanese Industrial Standard (JIS) 2001) of the machined hole machined using the drill 1 according to the present invention was 1.130 μm. On the other hand, the surface roughness Ry of the machined hole machined by electric discharge machining was 11.349 μm.

Accordingly, as compared with electric discharge machining, with the drill 1 according to the present invention, it is possible to perform machining so as to make the surface of the machined hole smooth, that is, it is possible to machine a hole with good accuracy.

Next, FIG. 9 is a diagram showing the results of a sixth efficiency test. The sixth efficiency test is a test conducted to examine the cutting efficiency of the drill 1 according to the present invention. In this test, at a predetermined cutting speed V and feed rate f, drilling to a hole depth of 5 mm is carried out by STEP machining, and the time required for the drilling is calculated for a comparison in efficiency between the machining according to the present invention and wire-cut machining. As for the required accuracy of a machined hole, the diameter dimension is set to 0.5 mm, and the dimensional tolerance is set to H7.

The detailed specifications of the sixth efficiency test are as follows: Work Material: PD613 (63HRC), Machining Depth: 5 mm, Outer Diameter D of Cutting Edge: 0.5 mm, Axial Dimension L of Drill Body: 10D, Cutting Speed V: 31.5 m/min, Feed Rate f: 0.02 mm/rev, and STEP amount: 0.05 mm.

As shown in FIG. 9, the time required for machining was 79 s (seconds) in a case where the drill 1 according to the present invention was used, whereas the time required for machining was 706 s in the case of wire-cut machining.

From the above results, with the drill 1 according to the present invention, cutting efficiency can be increased by 9 times in comparison to the case of wire-cut machining. At the same time, the drill 1 according to the present invention can provide a machined hole accuracy that is similar to that of wire-cut machining.

It should be noted that the time required for wire-cut machining refers to the time from the boring of a starting hole to the end of machining of a hole. Thus, the drill 1 according to the present invention can eliminate the machining time required for boring a starting hole to achieve a corresponding improvement in machining efficiency.

Further, the operation of passing a wire through a starting hole becomes unnecessary, thereby making it possible to achieve simplification of operation, and a reduction in operation time.

Although the present invention has been described above by way of its embodiments, the present invention is by no means limited to the respective embodiments mentioned above, and it can be easily inferred that various improvements and modifications are possible without departing from the scope of the present invention.

1. A drill comprising:
a drill body that is rotated about a center axis;
a flute portion formed in a spiral or substantially linear fashion in an outer peripheral surface portion from a tip of the drill body to a shank;
a leading edge formed in a ridge portion between a wall surface facing a direction of rotation of the flute portion and the outer peripheral surface portion; and
a cutting edge formed at the tip of the drill body,
wherein: a flute length of the flute portion which is a dimension along the center axis of the drill body is set to be within a range of 6D or more and 10D or less relative to an outer diameter D of the cutting edge;
at least the cutting edge has its surface coated with a hard compound selected from the group consisting of TiAlN, TiN, TiC, and TiCN;
a film thickness dimension of the hard compound is set to 1.0 μm or less; and
the cutting edge includes two edges;
the hard compound is adhered onto the cutting edge by a sputtering method after performing surface roughening means for impinging positive ions on a surface of the cutting edge through application of a negative bias voltage to the cutting edge, without Performing oxidation treatment of the surface; and
the surface roughening means applies the bias voltage periodically at a frequency that is set within a range of 150 kHz or more and 350 kHz or less, and a non-application time of a negative voltage at every one cycle is set to be within a range of 50 nsec or more and 2000 nsec or less.

2. The drill according to claim 1,
wherein: the outer diameter D of the cutting edge is set to 1.0 mm or less.

3. The drill according to claim 1,
wherein: a thickness dimension of a web thickness formed by a flute bottom of the flute portion is set to be within a range of 0.35D or more and 0.55D or less relative to the outer diameter D of the cutting edge.

4. (canceled)

5. (canceled)
